(19) United States
(12) Patent Application Publication
(10) Pub. No.: US 2024/0144355 A1
(43) Pub. Date: May 2, 2024

(54) SELECTING ORDER CHECKOUT OPTIONS

(71) Applicant: Maplebear Inc. (dba Instacart), San Francisco, CA (US)

(72) Inventors: Liang Chen, Sunnyvale, CA (US); Aman Jain, Toronto (CA); Xiangyu Wang, San Jose, CA (US); Houtao Deng, Sunnyvale, CA (US); Jae Cho, Bellevue, WA (US)

(21) Appl. No.: 17/977,712

(22) Filed: Oct. 31, 2022

(51) Int. Cl. G06Q 30/06; G06Q 30/02

(52) U.S. Cl. CPC G06Q 30/0641; G06Q 30/0201; G06Q 30/0607

(57) ABSTRACT

The present disclosure is directed to selecting order checkout options. In particular, the methods and systems of the present disclosure may, responsive to receiving data describing a potential order for an online shopping concierge platform: generate, based at least in part on the data describing the potential order, a plurality of different and distinct checkout options for the potential order; determine, for each checkout option of the plurality of different and distinct checkout options and based at least in part on one or more machine learning (ML) models, a probability that a customer associated with the potential order will proceed with the potential order if presented with the checkout option; and select a subset of checkout options for presentation to the customer based on their respective determined probabilities that the customer will proceed with the potential order if presented with the subset of checkout options.

### BACKGROUND

Online shopping concierge platforms may link shoppers with customers, enabling customers to request and receive products located at various remote geographic locations. To increase the efficiency of such platforms, customers, shoppers, and locations may be matched based on a wide variety of criteria, and/or the like.

### SUMMARY

Aspects and advantages of embodiments of the present disclosure will be set forth in part in the following description, or may be learned from the description, or may be learned through practice of the embodiments.

One example aspect of the present disclosure is directed to a method. The method may include, responsive to receiving data describing a potential order for an online shopping concierge platform: generating, by one or more computing devices and based at least in part on the data describing the potential order, a plurality of different and distinct checkout options for the potential order. The method may also include determining, for each checkout option of the plurality of different and distinct checkout options, by the computing device(s), and based at least in part on one or more machine learning (ML) models, a probability that a customer associated with the potential order will proceed with the potential order if presented with the checkout option. The method may further include selecting, by the computing device(s), a subset of checkout options from the plurality of different and distinct checkout options for presentation to the customer based on their respective determined probabilities that the customer will proceed with the potential order if presented with the subset of checkout options. The method may further include generating, by the computing device(s), data describing one or more graphical user interfaces (GUIs) comprising the subset of checkout options, and communicating, by the computing device(s) and to one or more computing devices associated with the customer, the data describing the GUI(s) comprising the subset of checkout options.

Another example aspect of the present disclosure is directed to a system. The system may include one or more processors, and a memory storing instructions that when executed by the processor(s) cause the system to perform operations. The operations may include training, based at least in part on a history of orders associated with an online shopping concierge platform, one or more machine learning (ML) models to determine a probability that presenting a given checkout option to a customer associated with a potential order will result in the customer proceeding with the potential order. The operations may also include determining, based at least in part on the ML model(s), the probability that presenting the given checkout option to the customer associated with the potential order will result in the customer proceeding with the potential order. The operations may further include generating data describing one or more graphical user interfaces (GUIs) comprising the given checkout option, and communicating, to one or more computing devices associated with the customer, the data describing the GUI(s) comprising the given checkout option.

A further example aspect of the present disclosure is directed to one or more non-transitory computer-readable media comprising instructions that when executed by one or more computing devices cause the computing device(s) to perform operations. The operations may include determining, based at least in part on one or more machine learning (ML) models, a probability that presenting a given checkout option to a customer associated with a potential order from an online shopping concierge platform will result in the customer proceeding with the potential order. The operations may also include selecting, from amongst a plurality of different and distinct checkout options, the given checkout option based at least in part upon the determined probability. The operations may further include generating data describing one or more graphical user interfaces (GUIs) comprising the given checkout option, and communicating, to a computing device associated with the customer, the data describing the GUI(s) comprising the given checkout option.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

FIG. 1 is a block diagram of a system environment in which an online system, such an online concierge system, operates, according to example embodiments of the present disclosure.

FIG. 2 illustrates an environment of an online shopping concierge service, according to example embodiments of the present disclosure.

FIG. 3 is a diagram of an online shopping concierge system, according to example embodiments of the present disclosure.

FIG. 4A is a diagram of a customer mobile application (CMA), according to example embodiments of the present disclosure.

FIG. 4B is a diagram of a shopper mobile application (SMA), according to example embodiments of the present disclosure.

FIG. 5 depicts an example system architecture according to example embodiments of the present disclosure; and

FIG. 6 depicts one or more example methods according to example embodiments of the present disclosure.

The figures depict embodiments of the present disclosure for purposes of illustration only. Alternative embodiments of the structures and methods illustrated herein may be employed without departing from the principles, or benefits touted, of the disclosure described herein.

### DETAILED DESCRIPTION

### System Architecture

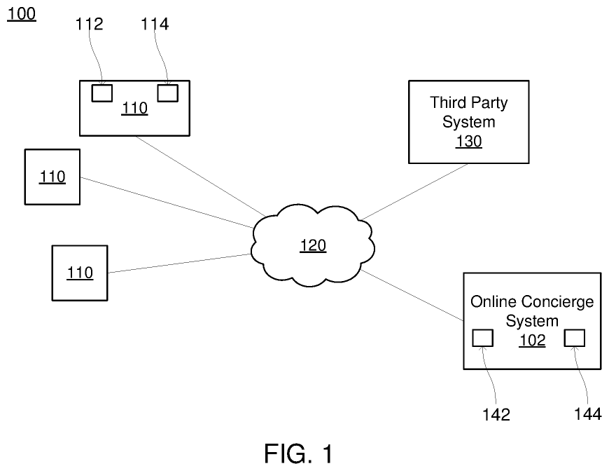

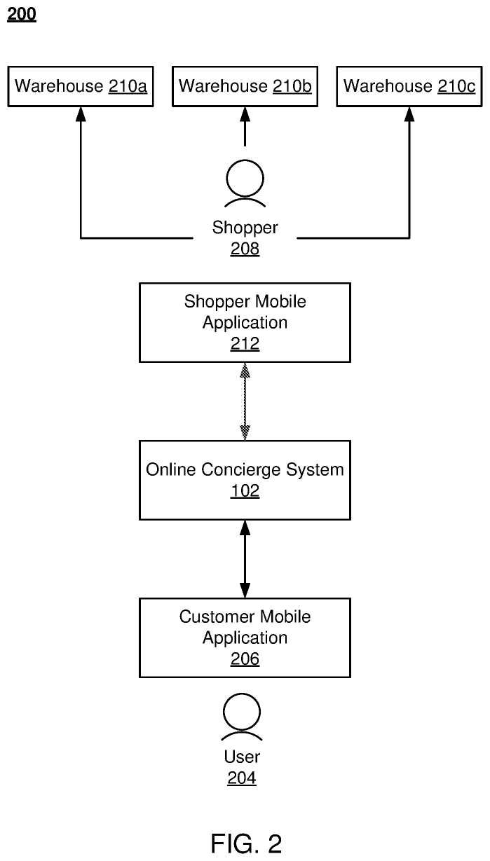

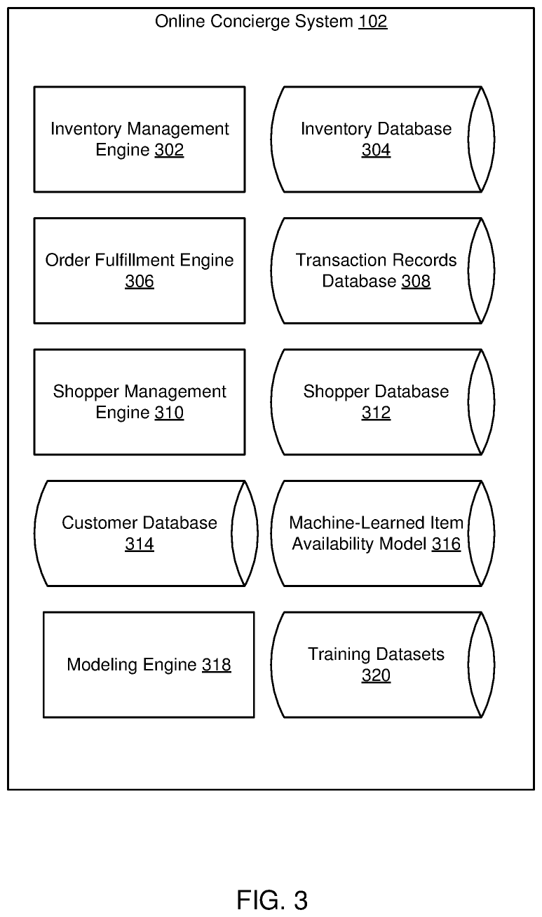

FIG. 1 is a block diagram of a system environment 100 in which an online system, such as an online concierge system 102 as further described below in conjunction with FIGS. 2 and 3, operates. The system environment 100 shown by FIG. 1 comprises one or more client devices 110, a network 120, one or more third-party systems 130, and the online concierge system 102. In alternative configurations, different and/or additional components may be included in the system environment 100. Additionally, in other embodiments, the online concierge system 102 may be replaced by an online system configured to retrieve content for display to users and to transmit the content to one or more client devices 110 for display.

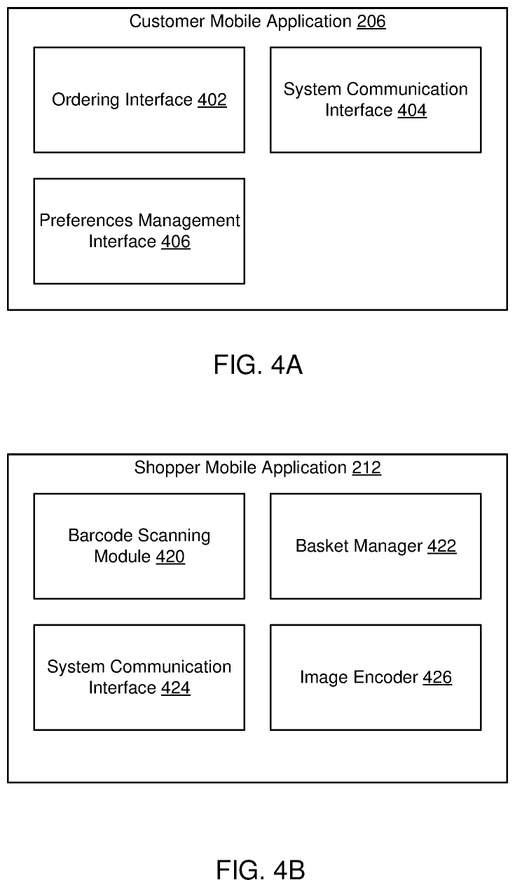

The client devices 110 are one or more computing devices capable of receiving user input as well as transmitting and/or receiving data via the network 120. In one or more embodiments, a client device 110 is a computer system, such as a desktop or a laptop computer. Alternatively, a client device 110 may be a device having computer functionality, such as a personal digital assistant (PDA), a mobile telephone, a smartphone, or another suitable device. A client device 110 is configured to communicate via the network 120. In one or more embodiments, a client device 110 executes an application allowing a user of the client device 110 to interact with the online concierge system 102. For example, the client device 110 executes a customer mobile application 206 or a shopper mobile application 212, as further described below in conjunction with FIGS. 4A and 4B, respectively, to enable interaction between the client device 110 and the online concierge system 102. As another example, a client device 110 executes a browser application to enable interaction between the client device 110 and the online concierge system 102 via the network 120. In other embodiments, a client device 110 interacts with the online concierge system 102 through an application programming interface (API) running on a native operating system of the client device 110, such as IOS® or ANDROID™.

A client device 110 includes one or more processors 112 configured to control operation of the client device 110 by performing functions. In various embodiments, a client device 110 includes a memory 114 comprising a non-transitory storage medium on which instructions are encoded. The memory 114 may have instructions encoded thereon that, when executed by the processor 112, cause the processor to perform functions to execute the customer mobile application 206 or the shopper mobile application 212 to provide the functions further described above in conjunction with FIGS. 4A and 4B, respectively.

The client devices 110 are configured to communicate via the network 120, which may comprise any combination of local area and/or wide area networks, using both wired and/or wireless communication systems. In one or more embodiments, the network 120 uses standard communications technologies and/or protocols. For example, the network 120 includes communication links using technologies such as Ethernet, 802.11, worldwide interoperability for microwave access (WiMAX), 3G, 4G, 5G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

One or more third party systems 130 may be coupled to the network 120 for communicating with the online concierge system 102 or with the one or more client devices 110. In one or more embodiments, a third party system 130 is an application provider communicating information describing applications for execution by a client device 110 or communicating data to client devices 110 for use by an application executing on the client device. In other embodiments, a third party system 130 provides content or other information for presentation via a client device 110. For example, the third party system 130 stores one or more web pages and transmits the web pages to a client device 110 or to the online concierge system 102. The third party system 130 may also communicate information to the online concierge system 102, such as advertisements, content, or information about an application provided by the third party system 130.

The online concierge system 102 includes one or more processors 142 configured to control operation of the online concierge system 102 by performing functions. In various embodiments, the online concierge system 102 includes a memory 144 comprising a non-transitory storage medium on which instructions are encoded. The memory 144 may have instructions encoded thereon corresponding to the modules described further below in conjunction with FIG. 3 that, when executed by the processor 142, cause the processor to perform the functionality further described above in conjunction with FIGS. 2, 5, and 6. For example, the memory 144 may have instructions encoded thereon that, when executed by the processor 142, may cause the processor 142 to, responsive to receiving data describing a potential order for an online shopping concierge platform: generate, based at least in part on the data describing the potential order, a plurality of different and distinct checkout options for the order; determine, for each checkout option of the plurality of different and distinct checkout options and based at least in part on one or more machine learning (ML) models, a probability that a customer associated with the potential order will proceed with the potential order if presented with the checkout option; and select a subset of checkout options from the plurality of different and distinct checkout options for presentation to the customer based on their respective determined probabilities that the customer will proceed with the order if presented with the subset of checkout options. Additionally, the online concierge system 102 may include a communication interface configured to connect the online concierge system 102 to one or more networks, such as network 120, or to otherwise communicate with devices (e.g., client devices 110) connected to the one or more networks.

One or more of a client device, a third party system 130, or the online concierge system 102 may be special purpose computing devices configured to perform specific functions, as further described below in conjunction with FIGS. 2-6, and may include specific computing components such as processors, memories, communication interfaces, and/or the like.

### System Overview

FIG. 2 illustrates an environment 200 of an online platform, such as an online concierge system 102, according to example embodiments of the present disclosure. The figures use like reference numerals to identify like elements. A letter after a reference numeral, such as “210a,” indicates that the text refers specifically to the element having that particular reference numeral. A reference numeral in the text without a following letter, such as “210,” refers to any or all of the elements in the figures bearing that reference numeral. For example, “210” in the text refers to reference numerals “210a” or “210b” in the figures.

The environment 200 includes an online concierge system 102. The online concierge system 102 is configured to receive orders from one or more users 204 (only one is shown for the sake of simplicity). An order specifies a list of goods (items or products) to be delivered to the user 204. The order also specifies the location to which the goods are to be delivered, and a time window during which the goods should be delivered. In some embodiments, the order specifies one or more retailers from which the selected items should be purchased. The user may use a customer mobile application (CMA) 206 to place the order; the CMA 206 is configured to communicate with the online concierge system 102.

The online concierge system 102 is configured to transmit orders received from users 204 to one or more shoppers 208. A shopper 208 may be a contractor, employee, other person (or entity), robot, or other autonomous device enabled to fulfill orders received by the online concierge system 202. The shopper 208 travels between a warehouse and a delivery location (e.g., the user's home or office). A shopper 208 may travel by car, truck, bicycle, scooter, foot, or other mode of transportation. In some embodiments, the delivery may be partially or fully automated, e.g., using a self-driving car. The environment 200 also includes three warehouses 210a, 210b, and 210c (only three are shown for the sake of simplicity; the environment could include hundreds of warehouses). The warehouses 210 may be physical retailers, such as grocery stores, discount stores, department stores, etc., or non-public warehouses storing items that can be collected and delivered to users. Each shopper 208 fulfills an order received from the online concierge system 102 at one or more warehouses 210, delivers the order to the user 204, or performs both fulfillment and delivery. In one or more embodiments, shoppers 208 make use of a shopper mobile application 212 which is configured to interact with the online concierge system 102.

FIG. 3 is a diagram of an online concierge system 102, according to example embodiments of the present disclosure. In various embodiments, the online concierge system 102 may include different or additional modules than those described in conjunction with FIG. 3. Further, in some embodiments, the online concierge system 102 includes fewer modules than those described in conjunction with FIG. 3.

The online concierge system 102 includes an inventory management engine 302, which interacts with inventory systems associated with each warehouse 210. In one or more embodiments, the inventory management engine 302 requests and receives inventory information maintained by the warehouse 210. The inventory of each warehouse 210 is unique and may change over time. The inventory management engine 302 monitors changes in inventory for each participating warehouse 210. The inventory management engine 302 is also configured to store inventory records in an inventory database 304. The inventory database 304 may store information in separate records—one for each participating warehouse 210—or may consolidate or combine inventory information into a unified record. Inventory information includes attributes of items that include both qualitative and qualitative information about items, including size, color, weight, SKU, serial number, and so on. In one or more embodiments, the inventory database 304 also stores purchasing rules associated with each item, if they exist. For example, age-restricted items such as alcohol and tobacco are flagged accordingly in the inventory database 304. Additional inventory information useful for predicting the availability of items may also be stored in the inventory database 304. For example, for each item-warehouse combination (a particular item at a particular warehouse), the inventory database 304 may store a time that the item was last found, a time that the item was last not found (a shopper looked for the item but could not find it), the rate at which the item is found, and the popularity of the item.

For each item, the inventory database 304 identifies one or more attributes of the item and corresponding values for each attribute of an item. For example, the inventory database 304 includes an entry for each item offered by a warehouse 210, with an entry for an item including an item identifier that uniquely identifies the item. The entry includes different fields, with each field corresponding to an attribute of the item. A field of an entry includes a value for the attribute corresponding to the attribute for the field, allowing the inventory database 304 to maintain values of different categories for various items.

In various embodiments, the inventory management engine 302 maintains a taxonomy of items offered for purchase by one or more warehouses 210. For example, the inventory management engine 302 receives an item catalog from a warehouse 210 identifying items offered for purchase by the warehouse 210. From the item catalog, the inventory management engine 202 determines a taxonomy of items offered by the warehouse 210. different levels in the taxonomy providing different levels of specificity about items included in the levels. In various embodiments, the taxonomy identifies a category and associates one or more specific items with the category. For example, a category identifies “milk,” and the taxonomy associates identifiers of different milk items (e.g., milk offered by different brands, milk having one or more different attributes, etc.), with the category. Thus, the taxonomy maintains associations between a category and specific items offered by the warehouse 210 matching the category. In some embodiments, different levels in the taxonomy identify items with differing levels of specificity based on any suitable attribute or combination of attributes of the items. For example, different levels of the taxonomy specify different combinations of attributes for items, so items in lower levels of the hierarchical taxonomy have a greater number of attributes, corresponding to greater specificity in a category, while items in higher levels of the hierarchical taxonomy have a fewer number of attributes, corresponding to less specificity in a category. In various embodiments, higher levels in the taxonomy include less detail about items, so greater numbers of items are included in higher levels (e.g., higher levels include a greater number of items satisfying a broader category). Similarly, lower levels in the taxonomy include greater detail about items, so fewer numbers of items are included in the lower levels (e.g., higher levels include a fewer number of items satisfying a more specific category). The taxonomy may be received from a warehouse 210 in various embodiments. In other embodiments, the inventory management engine 302 applies a trained classification module to an item catalog received from a warehouse 210 to include different items in levels of the taxonomy, so application of the trained classification model associates specific items with categories corresponding to levels within the taxonomy.

Inventory information provided by the inventory management engine 302 may supplement the training datasets 320. Inventory information provided by the inventory management engine 302 may not necessarily include information about the outcome of picking a delivery order associated with the item, whereas the data within the training datasets 320 is structured to include an outcome of picking a delivery order (e.g., if the item in an order was picked or not picked).

The online concierge system 102 also includes an order fulfillment engine 306 which is configured to synthesize and display an ordering interface to each user 204 (for example, via the customer mobile application 206). The order fulfillment engine 306 is also configured to access the inventory database 304 in order to determine which products are available at which warehouse 210. The order fulfillment engine 306 may supplement the product availability information from the inventory database 234 with an item availability predicted by the machine-learned item availability model 316. The order fulfillment engine 306 determines a sale price for each item ordered by a user 204. Prices set by the order fulfillment engine 306 may or may not be identical to in-store prices determined by retailers (which is the price that users 204 and shoppers 208 would pay at the retail warehouses). The order fulfillment engine 306 also facilitates transactions associated with each order. In one or more embodiments, the order fulfillment engine 306 charges a payment instrument associated with a user 204 when he/she places an order. The order fulfillment engine 306 may transmit payment information to an external payment gateway or payment processor. The order fulfillment engine 306 stores payment and transactional information associated with each order in a transaction records database 308.

In various embodiments, the order fulfillment engine 306 generates and transmits a search interface to a client device of a user for display via the customer mobile application 106. The order fulfillment engine 306 receives a query comprising one or more terms from a user and retrieves items satisfying the query, such as items having descriptive information matching at least a portion of the query. In various embodiments, the order fulfillment engine 306 leverages item embeddings for items to retrieve items based on a received query. For example, the order fulfillment engine 306 generates an embedding for a query and determines measures of similarity between the embedding for the query and item embeddings for various items included in the inventory database 304.

In some embodiments, the order fulfillment engine 306 also shares order details with warehouses 210. For example, after successful fulfillment of an order, the order fulfillment engine 306 may transmit a summary of the order to the appropriate warehouses 210. The summary may indicate the items purchased, the total value of the items, and in some cases, an identity of the shopper 208 and user 204 associated with the transaction. In one or more embodiments, the order fulfillment engine 306 pushes transaction and/or order details asynchronously to retailer systems. This may be accomplished via use of webhooks, which enable programmatic or system-driven transmission of information between web applications. In another embodiment, retailer systems may be configured to periodically poll the order fulfillment engine 306, which provides detail of all orders which have been processed since the last request.

The order fulfillment engine 306 may interact with a shopper management engine 310, which manages communication with and utilization of shoppers 208. In one or more embodiments, the shopper management engine 310 receives a new order from the order fulfillment engine 306. The shopper management engine 310 identifies the appropriate warehouse 210 to fulfill the order based on one or more parameters, such as a probability of item availability determined by a machine-learned item availability model 316, the contents of the order, the inventory of the warehouses, and the proximity to the delivery location. The shopper management engine 310 then identifies one or more appropriate shoppers 208 to fulfill the order based on one or more parameters, such as the shoppers' proximity to the appropriate warehouse 210 (and/or to the user 204), his/her familiarity level with that particular warehouse 210, and so on. Additionally, the shopper management engine 310 accesses a shopper database 312 which stores information describing each shopper 208, such as his/her name, gender, rating, previous shopping history, and so on.

As part of fulfilling an order, the order fulfillment engine 306 and/or shopper management engine 310 may access a user database 314 which stores information describing each user. This information could include each user's name, address, gender, shopping preferences, favorite items, stored payment instruments, and so on.

In various embodiments, the order fulfillment engine 306 determines whether to delay display of a received order to shoppers for fulfillment by a time interval. In response to determining to delay the received order by a time interval, the order fulfillment engine 306 evaluates orders received after the received order and during the time interval for inclusion in one or more batches that also include the received order. After the time interval, the order fulfillment engine 306 displays the order to one or more shoppers via the shopper mobile application 212; if the order fulfillment engine 306 generated one or more batches including the received order and one or more orders received after the received order and during the time interval, the one or more batches are also displayed to one or more shoppers via the shopper mobile application 212.

### Machine Learning Models

The online concierge system 102 further includes a machine-learned item availability model 316, a modeling engine 318, and training datasets 320. The modeling engine 318 uses the training datasets 320 to generate the machine-learned item availability model 316. The machine-learned item availability model 316 can learn from the training datasets 320, rather than follow only explicitly programmed instructions. The inventory management engine 302, order fulfillment engine 306, and/or shopper management engine 310 can use the machine-learned item availability model 316 to determine a probability that an item is available at a warehouse 210. The machine-learned item availability model 316 may be used to predict item availability for items being displayed to or selected by a user or included in received delivery orders. A single machine-learned item availability model 316 is used to predict the availability of any number of items.

The machine-learned item availability model 316 can be configured to receive as inputs information about an item, the warehouse for picking the item, and the time for picking the item. The machine-learned item availability model 316 may be adapted to receive any information that the modeling engine 318 identifies as indicators of item availability. At minimum, the machine-learned item availability model 316 receives information about an item-warehouse pair, such as an item in a delivery order and a warehouse at which the order could be fulfilled. Items stored in the inventory database 304 may be identified by item identifiers. As described above, various characteristics, some of which are specific to the warehouse (e.g., a time that the item was last found in the warehouse, a time that the item was last not found in the warehouse, the rate at which the item is found, the popularity of the item) may be stored for each item in the inventory database 304. Similarly, each warehouse may be identified by a warehouse identifier and stored in a warehouse database along with information about the warehouse. A particular item at a particular warehouse may be identified using an item identifier and a warehouse identifier. In other embodiments, the item identifier refers to a particular item at a particular warehouse, so that the same item at two different warehouses is associated with two different identifiers. For convenience, both of these options to identify an item at a warehouse are referred to herein as an “item-warehouse pair.” Based on the identifier(s), the online concierge system 102 can extract information about the item and/or warehouse from the inventory database 304 and/or warehouse database and provide this extracted information as inputs to the item availability model 316.

The machine-learned item availability model 316 contains a set of functions generated by the modeling engine 318 from the training datasets 320 that relate the item, warehouse, and timing information, and/or any other relevant inputs, to the probability that the item is available at a warehouse. Thus, for a given item-warehouse pair, the machine-learned item availability model 316 outputs a probability that the item is available at the warehouse. The machine-learned item availability model 316 constructs the relationship between the input item-warehouse pair, timing, and/or any other inputs and the availability probability (also referred to as “availability”) that is generic enough to apply to any number of different item-warehouse pairs. In some embodiments, the probability output by the machine-learned item availability model 316 includes a confidence score. The confidence score may be the error or uncertainty score of the output availability probability and may be calculated using any standard statistical error measurement. In some examples, the confidence score is based in part on whether the item-warehouse pair availability prediction was accurate for previous delivery orders (e.g., if the item was predicted to be available at the warehouse and not found by the shopper or predicted to be unavailable but found by the shopper). In some examples, the confidence score is based in part on the age of the data for the item, e.g., if availability information has been received within the past hour, or the past day. The set of functions of the item availability model 316 may be updated and adapted following retraining with new training datasets 320. The machine-learned item availability model 316 may be any machine learning model, such as a neural network, boosted tree, gradient boosted tree or random forest model. In some examples, the machine-learned item availability model 316 is generated from XGBoost algorithm.

The item probability generated by the machine-learned item availability model 316 may be used to determine instructions delivered to the user 204 and/or shopper 208, as described in further detail below.

The training datasets 320 relate a variety of different factors to known item availabilities from the outcomes of previous delivery orders (e.g., if an item was previously found or previously unavailable). The training datasets 320 include the items included in previous delivery orders, whether the items in the previous delivery orders were picked, warehouses associated with the previous delivery orders, and a variety of characteristics associated with each of the items (which may be obtained from the inventory database 204). Each piece of data in the training datasets 320 includes the outcome of a previous delivery order (e.g., if the item was picked or not). The item characteristics may be determined by the machine-learned item availability model 316 to be statistically significant factors predictive of the item's availability. For different items, the item characteristics that are predictors of availability may be different. For example, an item type factor might be the best predictor of availability for dairy items, whereas a time of day may be the best predictive factor of availability for vegetables. For each item, the machine-learned item availability model 316 may weight these factors differently, where the weights are a result of a “learning” or training process on the training datasets 320. The training datasets 320 are very large datasets taken across a wide cross section of warehouses, shoppers, items, warehouses, delivery orders, times, and item characteristics. The training datasets 320 are large enough to provide a mapping from an item in an order to a probability that the item is available at a warehouse. In addition to previous delivery orders, the training datasets 320 may be supplemented by inventory information provided by the inventory management engine 302. In some examples, the training datasets 320 are historic delivery order information used to train the machine-learned item availability model 316, whereas the inventory information stored in the inventory database 304 include factors input into the machine-learned item availability model 316 to determine an item availability for an item in a newly received delivery order. In some examples, the modeling engine 318 may evaluate the training datasets 320 to compare a single item's availability across multiple warehouses to determine if an item is chronically unavailable. This may indicate that an item is no longer manufactured. The modeling engine 318 may query a warehouse 210 through the inventory management engine 302 for updated item information on these identified items.

### Machine Learning Factors

The training datasets 320 include a time associated with previous delivery orders. In some embodiments, the training datasets 320 include a time of day at which each previous delivery order was placed. Time of day may impact item availability, since during high-volume shopping times, items may become unavailable that are otherwise regularly stocked by warehouses. In addition, availability may be affected by restocking schedules, e.g., if a warehouse mainly restocks at night, item availability at the warehouse will tend to decrease over the course of the day. Additionally, or alternatively, the training datasets 320 include a day of the week previous delivery orders were placed. The day of the week may impact item availability since popular shopping days may have reduced inventory of items or restocking shipments may be received on particular days. In some embodiments, training datasets 320 include a time interval since an item was previously picked in a previous delivery order. If an item has recently been picked at a warehouse, this may increase the probability that it is still available. If there has been a long time interval since an item has been picked, this may indicate that the probability that it is available for subsequent orders is low or uncertain. In some embodiments, training datasets 320 include a time interval since an item was not found in a previous delivery order. If there has been a short time interval since an item was not found, this may indicate that there is a low probability that the item is available in subsequent delivery orders. And conversely, if there has been a long time interval since an item was not found, this may indicate that the item may have been restocked and is available for subsequent delivery orders. In some examples, training datasets 320 may also include a rate at which an item is typically found by a shopper at a warehouse, a number of days since inventory information about the item was last received from the inventory management engine 302, a number of times an item was not found in a previous week, or any number of additional rate or time information. The relationships between this time information and item availability are determined by the modeling engine 318 training a machine learning model with the training datasets 320, producing the machine-learned item availability model 316.

The training datasets 320 include item characteristics. In some examples, the item characteristics include a department associated with the item. For example, if the item is yogurt, it is associated with the dairy department. The department may be the bakery, beverage, nonfood, and pharmacy, produce and floral, deli, prepared foods, meat, seafood, dairy, the meat department, or dairy department, or any other categorization of items used by the warehouse. The department associated with an item may affect item availability, since different departments have different item turnover rates and inventory levels. In some examples, the item characteristics include an aisle of the warehouse associated with the item. The aisle of the warehouse may affect item availability since different aisles of a warehouse may be more frequently re-stocked than others. Additionally, or alternatively, the item characteristics include an item popularity score. The item popularity score for an item may be proportional to the number of delivery orders received that include the item. An alternative or additional item popularity score may be provided by a retailer through the inventory management engine 302. In some examples, the item characteristics include a product type associated with the item. For example, if the item is a particular brand of a product, then the product type will be a generic description of the product type, such as “milk” or “eggs.” The product type may affect the item availability, since certain product types may have a higher turnover and re-stocking rate than others or may have larger inventories in the warehouses. In some examples, the item characteristics may include a number of times a shopper was instructed to keep looking for the item after he or she was initially unable to find the item, a total number of delivery orders received for the item, whether or not the product is organic, vegan, gluten free, or any other characteristics associated with an item. The relationships between item characteristics and item availability are determined by the modeling engine 318 training a machine learning model with the training datasets 320, producing the machine-learned item availability model 316.

The training datasets 320 may include additional item characteristics that affect the item availability and can therefore be used to build the machine-learned item availability model 316 relating the delivery order for an item to its predicted availability. The training datasets 320 may be periodically updated with recent previous delivery orders. The training datasets 320 may be updated with item availability information provided directly from shoppers 208. Following updating of the training datasets 320, a modeling engine 318 may retrain a model with the updated training datasets 320 and produce a new machine-learned item availability model 316.

### Customer Mobile Application

FIG. 4A is a diagram of the customer mobile application (CMA) 206, according to example embodiments of the present disclosure. The CMA 206 includes an ordering interface 402, which provides an interactive interface with which the user 104 can browse through and select products and place an order. The CMA 206 also includes a system communication interface 404 which, among other functions, receives inventory information from the online shopping concierge system 102 and transmits order information to the system 202. The CMA 206 also includes a preferences management interface 406 which allows the user 104 to manage basic information associated with his/her account, such as his/her home address and payment instruments. The preferences management interface 406 may also allow the user to manage other details such as his/her favorite or preferred warehouses 210, preferred delivery times, special instructions for delivery, and so on.

### Shopper Mobile Application

FIG. 4B is a diagram of the shopper mobile application (SMA) 212, according to example embodiments of the present disclosure. The SMA 212 includes a barcode scanning module 420 which allows a shopper 208 to scan an item at a warehouse 210 (such as a can of soup on the shelf at a grocery store). The barcode scanning module 420 may also include an interface which allows the shopper 108 to manually enter information describing an item (such as its serial number, SKU, quantity and/or weight) if a barcode is not available to be scanned. SMA 212 also includes a basket manager 422 which maintains a running record of items collected by the shopper 208 for purchase at a warehouse 210. This running record of items is commonly known as a “basket.” In one or more embodiments, the barcode scanning module 420 transmits information describing each item (such as its cost, quantity, weight, etc.) to the basket manager 422, which updates its basket accordingly. The SMA 212 also includes a system communication interface 424 which interacts with the online shopping concierge system 102. For example, the system communication interface 424 receives an order from the online concierge system 102 and transmits the contents of a basket of items to the online concierge system 102. The SMA 212 also includes an image encoder 426 which encodes the contents of a basket into an image. For example, the image encoder 426 may encode a basket of goods (with an identification of each item) into a QR code which can then be scanned by an employee of the warehouse 210 at check-out.

### Determining Checkout Options

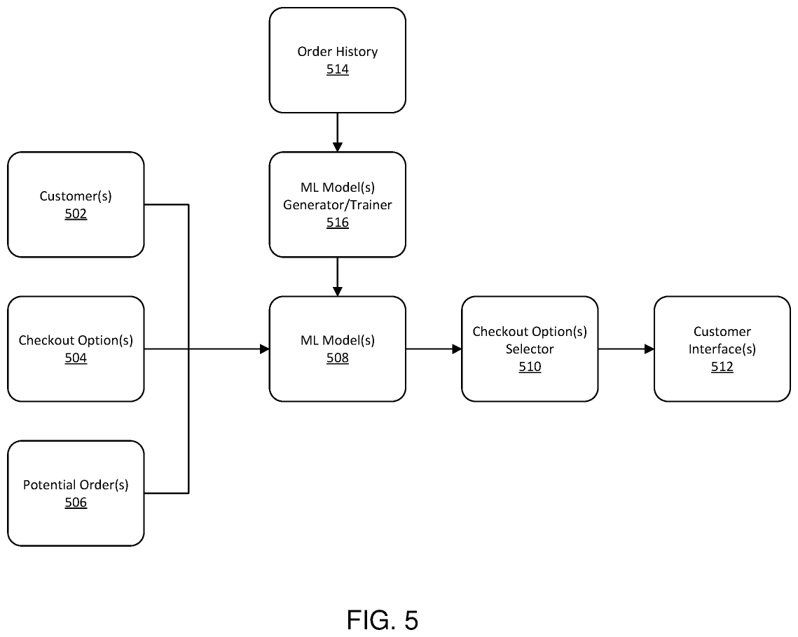

FIG. 5 depicts an example system architecture according to example embodiments of the present disclosure.

Referring to FIG. 5, one or more computing devices (e.g., associated with online concierge system 102, and/or the like) may receive data describing a potential order (e.g., one or more of potential order(s) 506, and/or the like) for the online shopping concierge platform. Responsive to receiving the data describing the potential order, the computing device(s) may generate (e.g., based at least in part on the data describing the potential order, and/or the like) a plurality of different and distinct checkout options (e.g., one or more of checkout option(s) 504, and/or the like) for the order. The computing device(s) may also determine (e.g., based at least in part on ML model(s) 508, and/or the like), for each of the plurality of different and distinct checkout options, a probability that a customer (e.g., one or more of customer(s) 502, and/or the like) associated with the potential order will proceed with the potential order if presented with the checkout option, a probability that presenting the checkout option to the customer associated with the potential order will result in the customer proceeding with the potential order, and/or the like.

The computing device(s) (e.g., via checkout option(s) selector 510, and/or the like) may select (e.g., for presentation to the customer, and/or the like) a checkout option, a subset of checkout options, and/or the like from the plurality of different and distinct checkout options based at least in part on their respective determined probabilities that the customer will proceed with the order if presented with the checkout option(s), and/or the like. The computing device(s) (e.g., via customer interface(s) 512, and/or the like) may further generate one or more GUIs comprising the selected checkout option(s), and may communicate (e.g., to one or more computing devices associated with the customer, and/or the like) such GUIs.

In some embodiments, ML model(s) 508 may be configured to accept as input one or more features, properties, and/or the like of customer(s) 502, and/or the like. In some of such embodiments, determining the one or more probabilities for one or more of checkout option(s) 504 may include determining such probabilities based at least in part on such feature(s), properties, and/or the like. For example, such feature(s), properties, and/or the like may include a geographic location of the customer, a current time or date associated with the customer, a status level of the customer with the online shopping concierge platform, an order history of the customer with the online shopping concierge platform, and/or the like.

In some embodiments, ML model(s) 508 may be configured to accept as input one or more features, properties, and/or the like of potential order(s) 506, and/or the like. In some of such embodiments, determining the one or more probabilities for one or more of the checkout option(s) 504 may include determining such probabilities based at least in part on such feature(s), properties, and/or the like. For example, such feature(s), properties, and/or the like may include a geographic location associated with a warehouse from which to source the potential order, a market value of items associated with the potential order, a physical weight of items associated with the potential order, a number of items associated with the potential order, whether the potential order includes age-restricted items, and/or the like. For example, one or more of the probabilities may be determined based at least in part on one or more functions that combine one or more values associated with the feature(s), properties, and/or the like (e.g., by summing such value(s) and/or the product(s) of such value(s) and one or more weighting factors associated with the respective feature(s), properties, and/or the like).

In some embodiments, ML model(s) 508 may be configured to accept as input one or more features, properties, and/or the like of checkout option(s) 504 (e.g., one or more other of checkout option(s) 504, and/or the like). In some of such embodiments, determining the one or more probabilities for one or more of the checkout option(s) 504 may include determining such probabilities based at least in part on such feature(s), properties, and/or the like. For example, such feature(s), properties, and/or the like may include one or more delivery times associated with the checkout option(s), one or more scheduling options associated with the checkout option(s), one or more delivery fees or costs associated with the checkout option(s), an estimated amount of time the delivery will take, estimated total delivery fee, availability of one or more checkout options, and/or the like.

In some embodiments, selecting the checkout option(s) (e.g., for presentation to the customer, and/or the like) may include comparing a market value of items associated with the potential order against one or more costs associated with the checkout option(s), and/or the like. For example, the market value of the items may be compared against such associated cost(s) to determine a set of the checkout option(s) likely to be profitable for the online shopping concierge platform, a set of the checkout option(s) likely to cause the customer to proceed with the potential order, one or more intersections of such determined set(s), and/or the like.

The computing device(s) may (e.g., via ML model generator/trainer 516, and/or the like) generate, train, and/or the like one or more of ML model(s) 508, for example, based on order history 514 (e.g., past orders, their associated checkout options, and/or the like).

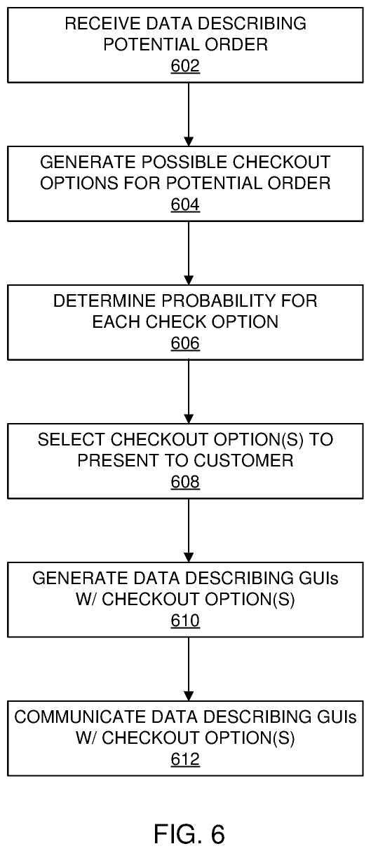

FIG. 6 depicts one or more example methods according to example embodiments of the present disclosure. In various embodiments, the method(s) may include different or additional steps than those described in conjunction with FIG. 6. Further, in some embodiments, the steps of the method(s) may be performed in different orders than the order described in conjunction with FIG. 6. The method(s) described in conjunction with FIG. 6 may be carried out, for example, by the online concierge system 102 in various embodiments, while in other embodiments, the steps of the method(s) may be performed by any online system capable of retrieving items, performing one or more aspects of the functionality described herein, and/or the like.

Referring to FIG. 6, at (602), one or more computing devices may receive data describing a potential order for an online shopping concierge platform. For example, one or more computing devices (e.g., associated with online concierge system 102, and/or the like) may receive data describing one or more of potential order(s) 506, and/or the like.

At (604), the computing devices may generate (e.g., based at least in part on the data describing the potential order, and/or the like) a plurality of different and distinct checkout options for the potential order. For example, the computing device(s) may generate one or more of checkout option(s) 504.

At (606), the computing device(s) may determine, for each of the plurality of different and distinct checkout options and based at least in part on one or more ML models, a probability that a customer associated with the potential order will proceed with the potential order if presented with the checkout option, a probability that presenting the checkout option to the customer associated with the potential order will result in the customer proceeding with the potential order, and/or the like. For example, the computing device(s) may determine, for each of checkout option(s) 504, and/or the like and based at least in part on ML model(s) 508, and/or the like, a probability that a given one of customer(s) 502 will proceed with a given one of potential order(s) 506 if presented with one or more of checkout option(s) 504, a probability that presenting one or more of checkout option(s) 504 to the given customer will result in the given customer proceeding with the given potential order, and/or the like.

At (608), the computing device(s) may select one or more checkout options for presentation to the customer based on their respective determined probabilities, and/or the like. For example, the computing device(s) may select one or more of checkout option(s) 504 for presentation to the given customer based on their respective determined probabilities, and/or the like.

At (610), the computing device(s) may generate data describing one or more GUIs comprising the selected checkout option(s), and/or the like. For example, the computing device(s) may generate data describing one or more GUIs comprising the one or more of checkout option(s) 504 selected for presentation to the given customer, and/or the like.

At (612), the computing device(s) may communicate (e.g., to one or more computing devices associated with the customer, and/or the like) the data describing the GUI(s) comprising the selected checkout option(s), and/or the like. By communicating such data (e.g., to the computing device(s) associated with the customer, and/or the like), the device(s) may cause the GUI(s) comprising the selected checkout option(s) (or one or more portions thereof) to be rendered, displayed, and/or the like (e.g., by the computing device(s) associated with the customer, and/or the like). For example, the computing device(s) may communicate (e.g., to one or more computing devices associated with the given customer, and/or the like) the data describing the GUI(s) comprising the one or more of checkout option(s) 504 selected for presentation to the given customer, and/or the like.

### Additional Considerations

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one or more embodiments, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a computing device selectively activated or reconfigured by a computer program stored in the computer. Such a computer program may be stored in a tangible computer readable storage medium, which includes any type of tangible media suitable for storing electronic instructions and coupled to a computer system bus. Furthermore, any computing systems referred to in the specification may include a single processor or may be architectures employing multiple processor designs for increased computing capability.

Embodiments of the invention may also relate to a computer data signal embodied in a carrier wave, where the computer data signal includes any embodiment of a computer program product or other data combination described herein. The computer data signal is a product that is presented in a tangible medium or carrier wave and modulated or otherwise encoded in the carrier wave, which is tangible, and transmitted according to any suitable transmission method.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method comprising:
responsive to receiving data describing a potential order for an online shopping concierge platform:
generating, by one or more computing devices and based at least in part on the data describing the potential order, a plurality of different and distinct checkout options for the potential order;
determining, for each checkout option of the plurality of different and distinct checkout options, by the one or more computing devices, and
based at least in part on one or more machine learning (ML) models, a probability that a customer associated with the potential order will proceed with the potential order if presented with the checkout option;
selecting, by the one or more computing devices, a subset of checkout options from the plurality of different and distinct checkout options for presentation to the customer based on their respective determined probabilities that the customer will proceed with the potential order if presented with the subset of checkout options;
generating, by the one or more computing devices, data describing one or more graphical user interfaces (GUIs) comprising the subset of checkout options; and
communicating, by the one or more computing devices and to one or more computing devices associated with the customer, the data describing the one or more GUIs comprising the subset of checkout options.

2. The method of claim 1, wherein:
the one or more ML models are configured to accept as input one or more features or properties of the customer; and
determining the probability that the customer associated with the potential order will proceed with the potential order if presented with the checkout option comprises determining the probability based at least in part on the one or more features or properties of the customer.

3. The method of claim 2, wherein the one or more features or properties of the customer comprise one or more of:
a geographic location of the customer;
a current time or date associated with the customer;
a status level of the customer with the online shopping concierge platform; or
an order history of the customer with the online shopping concierge platform.

4. The method of claim 1, wherein:
the one or more ML models are configured to accept as input one or more features or properties of the potential order; and
determining the probability that the customer associated with the potential order will proceed with the potential order if presented with the checkout option comprises determining the probability based at least in part on the one or more features or properties of the potential order.

5. The method of claim 1, wherein:
the one or more ML models are configured to accept as input one or more features or properties of one or more other checkout options of the plurality of different and distinct checkout options; and
determining the probability that the customer associated with the potential order will proceed with the potential order if presented with the checkout option comprises determining the probability based at least in part on the one or more features or properties of the one or more other checkout options.

6. The method of claim 5, wherein the one or more features or properties of the one or more other checkout options comprise one or more of:
one or more delivery times associated with the one or more other checkout options;
one or more scheduling options associated with the one or more other checkout options; or
one or more delivery fees or costs associated with the one or more other checkout options.

7. The method of claim 1, comprising training, by the one or more computing devices, the one or more ML models based at least in part on data describing previous orders and their associated checkout options.

8. The method of claim 1, wherein selecting the subset of checkout options comprises comparing a market value of items associated with the potential order against one or more costs associated with the subset of checkout options.

9. A system comprising:
one or more processors; and
a memory storing instructions that when executed by the one or more processors cause the system to perform operations comprising:
training, based at least in part on a history of orders associated with an online shopping concierge platform, one or more machine learning (ML) models to determine a probability that presenting a given checkout option to a customer associated with a potential order will result in the customer proceeding with the potential order;
determining, based at least in part on the one or more ML models, the probability that presenting the given checkout option to the customer associated with the potential order will result in the customer proceeding with the potential order;
generating data describing one or more graphical user interfaces (GUIs) comprising the given checkout option; and
communicating, to one or more computing devices associated with the customer, the data describing the one or more GUIs comprising the given checkout option.

10. The system of claim 9, wherein:
the one or more ML models are configured to accept as input one or more features or properties of the customer; and
determining the probability that presenting the given checkout option to the customer associated with the potential order will result in the customer proceeding with the potential order comprises determining the probability based at least in part on the one or more features or properties of the customer.

11. The system of claim 10, wherein the one or more features or properties of the customer comprise one or more of:
a geographic location of the customer;
a current time or date associated with the customer;
a status level of the customer with the online shopping concierge platform; or
an order history of the customer with the online shopping concierge platform.

12. The system of claim 9, wherein:
the one or more ML models are configured to accept as input one or more features or properties of the potential order; and
determining the probability that presenting the given checkout option to the customer associated with the potential order will result in the customer proceeding with the potential order comprises determining the probability based at least in part on the one or more features or properties of the potential order.

13. The system of claim 12, wherein the one or more features or properties of the potential order comprise one or more of:
a geographic location associated with a warehouse from which to source the potential order;
a market value of items associated with the potential order;
a physical weight of items associated with the potential order;
a number of items associated with the potential order; or
whether the potential order comprises age-restricted items.

14. The system of claim 9, wherein:
the one or more ML models are configured to accept as input one or more features or properties of one or more other checkout options; and
determining the probability that presenting the given checkout option to the customer associated with the potential order will result in the customer proceeding with the potential order comprises determining the probability based at least in part on the one or more features or properties of the one or more other checkout options.

15. The system of claim 14, wherein the one or more features or properties of the one or more other checkout options comprise one or more of:
one or more delivery times associated with the one or more other checkout options;
one or more scheduling options associated with the one or more other checkout options; or
one or more delivery fees or costs associated with the one or more other checkout options.

16. One or more non-transitory computer-readable media comprising instructions that when executed by one or more computing devices cause the one or more computing devices to perform operations comprising:
determining, based at least in part on one or more machine learning (ML) models, a probability that presenting a given checkout option to a customer associated with a potential order from an online shopping concierge platform will result in the customer proceeding with the potential order;
selecting, from amongst a plurality of different and distinct checkout options, the given checkout option based at least in part upon the determined probability;
generating data describing one or more graphical user interfaces (GUIs) comprising the given checkout option; and
communicating, to a computing device associated with the customer, the data describing the one or more GUIs comprising the given checkout option.

17. The one or more non-transitory computer-readable media of claim 16, wherein:
the one or more ML models are configured to accept as input one or more features or properties of the customer; and
determining the probability that presenting the given checkout option to the customer associated with the potential order will result in the customer proceeding with the potential order comprises determining the probability based at least in part on the one or more features or properties of the customer.

18. The one or more non-transitory computer-readable media of claim 16, wherein:
the one or more ML models are configured to accept as input one or more features or properties of the potential order; and
determining the probability that presenting the given checkout option to the customer associated with the potential order will result in the customer proceeding with the potential order comprises determining the probability based at least in part on the one or more features or properties of the potential order.

19. The one or more non-transitory computer-readable media of claim 16, wherein:
the one or more ML models are configured to accept as input one or more features or properties of one or more other checkout options of the plurality of different and distinct checkout options; and
determining the probability that presenting the given checkout option to the customer associated with the potential order will result in the customer proceeding with the potential order comprises determining the probability based at least in part on the one or more features or properties of the one or more other checkout options.

20. The one or more non-transitory computer-readable media of claim 16, wherein selecting the given checkout option comprises comparing a market value of items associated with the potential order against one or more costs associated with the given checkout option.
